(19) United States
(12) Patent Application Publication
(10) Pub. No.: US 2012/0261870 A1
(43) Pub. Date: Oct. 18, 2012

(54) PRINTED CIRCUIT BOARD, A SUPPORTING JIG AND A POSITIONING METHOD

(75) Inventors: Hao-Chun HSIEH, Taipei Hsien (TW); Sheng-Wen Cheng, Taipei Hsien (TW); Hsin-Lun Tsai, Taipei Hsien (TW); Chia-Hsien Lee, Taipei-Hsien (TW)

(73) Assignee: Wistron Corporation, Taipei Hsien (TW)

(21) Appl. No.: 13/444,046

(22) Filed: Apr. 11, 2012

(30) Foreign Application Priority Data
Apr. 13, 2011 (TW) 100112847

(51) Int. Cl. B25B 11/00; B23P 11/00

(52) U.S. Cl. 269/8; 29/464

(57) ABSTRACT

A printed circuit board, a supporting jig, and a positioning method are disclosed, wherein the supporting jig is used for positioning a printed circuit board to facilitate surface mount technology (SMT) procedures. The printed circuit board includes a circuit board locating hole, and a first magnet, wherein the first magnet is accommodated in the circuit board locating hole. The supporting jig has a jig locating hole and a second magnet. The jig locating hole is beneath the circuit board locating hole. The second magnet is accommodated in the jig locating hole so that the printed circuit board can be fixed on the supporting jig by the magnetic attraction between the first magnet and the second magnet.

### BACKGROUND OF THE INVENTION

1. Field of the Invention

The present invention relates to a printed circuit board, a supporting jig and a positioning method; more particularly, the present invention relates to a positioning method capable of fixing a printed circuit board on a supporting jig by means of magnetic attraction.

2. Description of the Related Art

Conventionally, the backlight source used in a liquid crystal display (LCD) is primarily a cold cathode fluorescent lamp (CCFL). However, with the price drop of a light emitting diode (LED), it has become the trend of replacing CCFL with LED as the panel backlight source. Especially, because the recent development trend is focused on large size LCD TVs, the application of LED is not limited to small and medium size panels any more. Therefore, LED light bar related problems become more important.

Conventionally, LEDs are used in small and medium size panel backlight sources with only 2 to 3 LEDs used, so the LED light bar related problem is relatively simple. However, laptop computers with 12.1-inch to 15.4-inch panels gradually adopts LED backlight sources with 20 to 40 LEDs used, and in recent years LCD TVs also adopt LED backlight sources with hundreds of LEDs used; therefore, the technical problem of the manufacturing process of the LED light bars is relatively complicated. Because the LED light bar manufacturing and assembly technology starts to get more attention in recent years, the industry needs a good manufacturing flow or jig for LED production, and the yield and manufacturing process technology for LED light bar production are even more urgent matters need to be solved.

Generally, the conventional LED light bar is manufactured by means of surface mount technology (SMT). Because the LED light bar is a bar-shaped structure, some machines or jigs need to be added to the production flow with regard to this characteristic to improve the yield. Please refer to FIG. 1, which illustrates a flowchart of a conventional surface mount technology according to a known prior art. As shown in FIG. 1, because the LED light bar is a bar-shaped structure and has a lighter weight, during the SMT procedure, the LED light bar would become bending deformation or adhesion and thus reducing the production yield. In order to increase the production yield, the known prior art usually make a supporting jig exclusive for the LED light bar to avoid LED light bar deformation during a solder paste printing process. Further, because the weight of the LED light bar is lighter than the weight of a common printed circuit board, an adhesive tape or vacuum suction device would be used for fixing the LED light bar on the supporting jig, so as to avoid adhesion between a printed steel sheet used in the solder paste printing process and the LED light bar, wherein the adhesion would prevent the printed steel sheet from being detached from the LED light bar. After the solder paste printing process, the LED would be put on the LED light bar, and then the LED light bar would be put into a solder reflow oven to complete a component soldering process. However, owing to the bar-shaped structure of the LED light bar, the light bar would bend during the solder reflow process due to the high temperature. Therefore, in the known prior art, a top cover for preventing the light bar from bending, would be placed on the LED light bar before the LED light bar is sent to the solder reflow oven. Then the supporting jig and the top cover would be detached after the soldering process, finally the LED light bar would be taken out.

However, during the process of placing the top cover, the assembled components might possibly be push thereby causing component shifting. If no top cover is used, then a powerful adhesive tape or powerful vacuum suction device has to be used for enhancing the bonding force between the LED light bar and the supporting jig, so as to prevent the LED light bar from deformation in the solder reflow oven due to the high temperature, wherein the deformation would result in a poor soldering quality. Besides, if a powerful adhesive tape is used, it would be very difficult to detach the LED light bar from the supporting jig after the soldering process; and purchasing the vacuum suction device would increase the manufacturing cost.

In a known prior art, a permanent magnet is provided in the back of a carrier board, and is combined with a top cover made of ferromagnetic material. Through the magnetic attraction between the top cover and the carrier board, the printed circuit board can be prevented from bending in the solder reflow oven due to the high temperature. However, according to the last paragraph, placing a top cover on the printed circuit board may cause component shifting.

Therefore, there is a need to provide an apparatus and method for fixing a LED light bar on a supporting jig without using a top cover and obviate the aforementioned problems.

### SUMMARY OF THE INVENTION

It is an object of the present invention to provide a printed circuit board and a supporting jig utilizing magnetic attraction, such that the printed circuit board can be fixed on the supporting jig.

To achieve the abovementioned object, the supporting jig of the present invention is used for positioning the printed circuit board, so as to facilitate a surface mount technology (SMT) procedure toward the printed circuit board. The printed circuit board comprises a circuit board locating hole and a first magnet, wherein the first magnet is accommodated in the circuit board locating hole. The supporting jig comprises: a jig locating hole and a second magnet. The jig locating hole is located beneath the circuit board locating hole, and the second magnet is accommodated in the jig locating hole. Therefore, the printed circuit board can be fixed on the supporting jig by the magnetic attraction between the first magnet and the second magnet. In one embodiment of the present invention, the circuit board locating hole can accommodate the first magnet by means of utilizing a geometric structure. For example, a side cross-sectional shape of the circuit board locating hole can be a rectangular or a taper.

The present invention further provides a positioning method, used for fixing the printed circuit board on the supporting jig to facilitate the SMT procedure toward the printed circuit board. The positioning method comprises the following steps: providing the circuit board locating hole on the printed circuit board; providing the jig locating hole on the supporting jig; accommodating the first magnet in the circuit board locating hole; accommodating the second magnet in the jig locating hole; and fixing the printed circuit board on the supporting jig by the magnetic attraction between the first magnet and the second magnet.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a flowchart of a conventional surface mount technology according to a known prior art.

FIG. 2 illustrates an exploded schematic view of a supporting jig and a printed circuit board according to the present invention.

FIG. 3 illustrates a cross-sectional view of a first embodiment of the supporting jig and a first embodiment of the printed circuit board according to the present invention.

FIG. 4 illustrates a cross-sectional view of a second embodiment of the printed circuit board according to the present invention.

FIG. 5 illustrates a cross-sectional view of a second embodiment of the supporting jig according to the present invention.

FIG. 6 illustrates a cross-sectional view of a third embodiment of the supporting jig according to the present invention.

FIG. 7 illustrates a flowchart of the positioning method according to the present invention.

### DETAILED DESCRIPTION OF THE PREFERRED EMBODIMENT

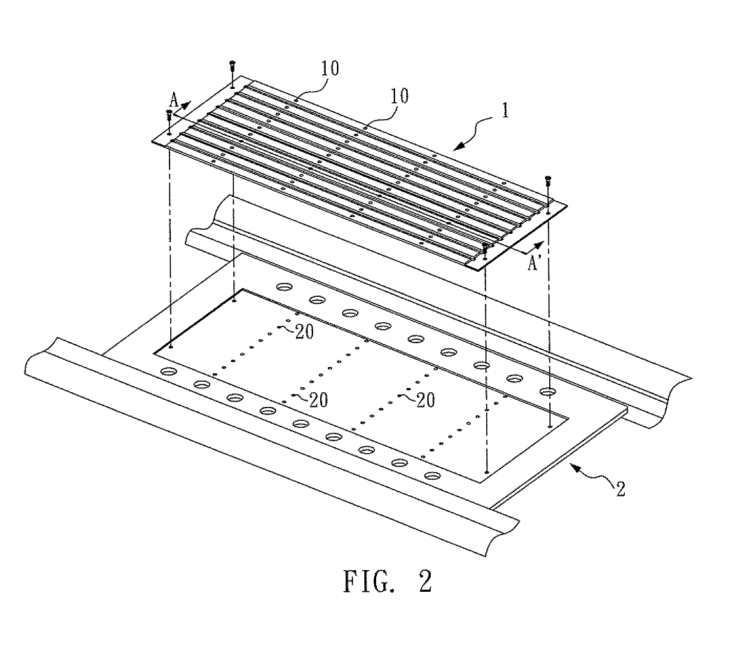

Please refer to FIG. 2, which illustrates an exploded schematic view of a supporting jig and a printed circuit board according to the present invention. As shown in FIG. 2, the printed circuit board 1 of the present invention is positioned on the supporting jig 2, so as to facilitate a surface mount technology (SMT) procedure toward the printed circuit board 1. In this embodiment, the printed circuit board 1 is, but not limited to, a light emitting diode (LED) light bar.

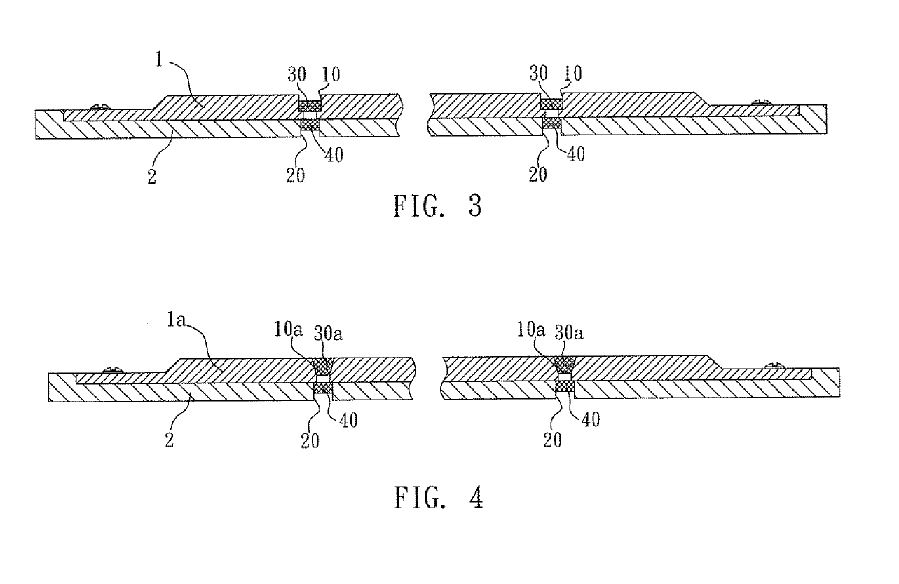

Please refer to FIG. 3, which illustrates a cross-sectional view of a first embodiment of the supporting jig and a first embodiment of the printed circuit board according to the present invention. Please note that the cross-sectional view in this specification refers to the A-A′ cross-sectional view of FIG. 2. As shown in FIG. 3, the supporting jig 2 of the present invention is used for positioning the printed circuit board 1. The printed circuit board 1 comprises a circuit board locating hole 10 and a first magnet 30, wherein the first magnet 30 is accommodated in the circuit board locating hole 10. The supporting jig 2 comprises: a jig locating hole 20 and a second magnet 40. The jig locating hole 20 is located beneath the circuit board locating hole 10. The second magnet 40 is accommodated in the jig locating hole 20. Therefore, the printed circuit board 1 can be fixed on the supporting jig 2 by the magnetic attraction between the first magnet 30 and the second magnet 40.

As shown in FIG. 3, a side cross-sectional shape of the circuit board locating hole 10 is wide at the top and narrow at the bottom (i.e. the top opening of the circuit board locating hole 10 is wider than the bottom opening of the circuit board locating hole 10). In this embodiment, the geometric shape of the circuit board locating hole 10 is a rectangular, and the shape of the first magnet 30 matches the shape of the circuit board locating hole 10. Further, because the bottom opening of the circuit board locating hole 10 is narrower than the width of the first magnet 30, the first magnet 30 can be prevented from being detached from the printed circuit board 1. Moreover, the jig locating hole 20 of this embodiment is a through hole, and the top opening of the jig locating hole 20 is also narrower than the width of the second magnet 40, such that the second magnet 40 can be positioned in the jig locating hole 20, so as to prevent the second magnet 40 from passing through the jig locating hole 20.

The printed circuit board 1 can be tightly fixed on the supporting jig 2 by the magnetic attraction between the first magnet 30 and the second magnet 40. As a result, not only the solder paste can be evenly applied on the printed circuit board 1, but also the printed circuit board 1 and the printed steel sheet for solder paste printing can be easily detached after the solder paste printing process so as to avoid adhesion. Meanwhile, the magnetic attraction between the first magnet 30 and the second magnet 40 makes the printed circuit board 1 tightly fix to the supporting jig 2, so as to prevent the printed circuit board 1 from bending or deformation during the SMT procedure. As shown in FIG. 3, the thicknesses of the first magnet 30 and the second magnet 40 in this embodiment are substantially smaller than the depths of the circuit board locating hole 10 and the jig locating hole 20, so as to prevent the first magnet 30 and/or the second magnet 40 from protruding from the printed circuit board 1 which may result in uneven solder paste thickness while printing the solder paste.

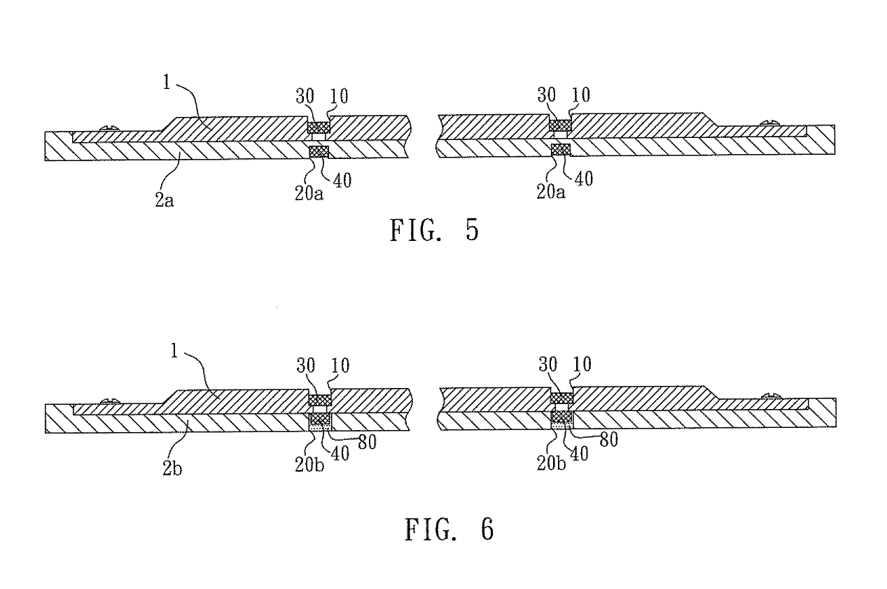

Please refer to FIG. 4, which illustrates a cross-sectional view of a second embodiment of the printed circuit board according to the present invention. As shown in FIG. 4, the side cross-sectional shape of the circuit board locating hole 10a of the printed circuit board la of the present invention is a taper, the side cross-sectional shape of the first magnet 30a is a taper, and the first magnet 30a substantially aligns with the surface of the printed circuit board 1a. Without being limited to the above description, the first magnet 30a is applicable as long as it does not protrude from the printed circuit board 1a. Please note that the shapes of the circuit board locating hole and the magnet are not limited to the above embodiment, the side cross-sectional shapes in figures are only used as examples, while any structure with its side cross-sectional shape wide at the top and narrow at the bottom is applicable for the present invention. Although the circuit board locating hole 10 and the jig locating hole 20 in the above embodiment utilize the geometric shapes of the circuit board locating hole 10 and the jig locating hole 20 to respectively fix the first magnet 30 and the second magnet 40 to the circuit board locating hole 10 and the jig locating hole 20, the method of utilizing the geometric shape of the jig locating hole 20 to fix the second magnet 40 is only one of the means for fixing the second magnet 40. The present invention further provides two more means for fixing the second magnet 40 respectively shown in FIG. 5 and FIG. 6.

Please refer to FIG. 5, which illustrates a cross-sectional view of a second embodiment of the supporting jig according to the present invention. The second magnet 40 can also be fixed by means of utilizing the structure of the supporting jig 2a itself. As shown FIG. 5, the jig locating hole 20a of the supporting jig 2a does not pass through the supporting jig 2a (the jig locating hole 2a does not have a top opening), and the second magnet 40 is accommodated within the jig locating hole 20a.

Please refer to FIG. 6, which illustrates a cross-sectional view of a third embodiment of the supporting jig according to the present invention. As shown in FIG. 6, the jig locating hole 20b is filled with adhesive, so as to fix the second magnet 40 to the jig locating hole 20b. In this embodiment, because the second magnet 40 is fixed to the jig locating hole 20b by way of adhesion, the shape of the second magnet 40 does not have to match the shape of the jig locating hole 20b.

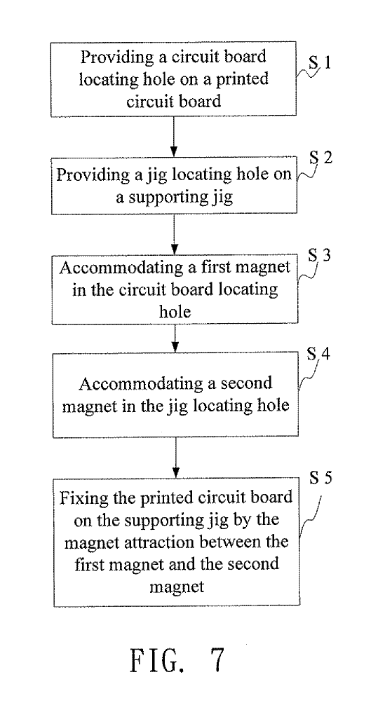

Please refer to FIG. 7, which illustrates a flowchart of the positioning method according to the present invention. The positioning method of the present invention is used for fixing the printed circuit board 1 shown in FIG. 2 or FIG. 3 onto the supporting jig 2, so as to facilitate the SMT procedure toward the printed circuit board 1. For better describing the present invention, the FIG. 3 will be used as an example for explaining the positioning method of the present invention, but please note that the positioning method of the present invention is not limited to be used in the structure shown in FIG. 3. As shown in FIG. 7, the positioning method of the present invention comprises the following steps:

Step S1: providing the circuit board locating hole 10 on the printed circuit board 1.

The present invention firstly performs step S1. As shown in FIG. 3, a circuit board locating hole 10 with a geometric shape wide at the top and narrow at the bottom is provided on the printed circuit board 1.

Step S2: providing the jig locating hole 20 on the supporting jig 2.

As shown in FIG. 3, the present invention then performs step S2. The jig locating hole 20 is provided on the supporting jig 2, and the jig locating hole 20 is located beneath the circuit board locating hole 10.

Step S3: accommodating the first magnet 30 in the circuit board locating hole 10.

As shown in FIG. 3, the present invention then performs step S3. The first magnet 30 is accommodated in the circuit board locating hole 10. The first magnet 30 is fixed to the circuit board locating hole 10 by means of the geometric structure of the circuit board locating hole 10.

Step S4: accommodating the second magnet 40 in the jig locating hole 20.

As shown in FIG. 3, the present invention then performs step S4. The second magnet 40 is accommodated in the jig locating hole 20. The second magnet 40 can be fixed to the jig locating hole 20 by means of the geometric structure of the jig locating hole 20, adhesive, or the structural design of the supporting jig 2.

Step S5: fixing the printed circuit board 1 on the supporting jig 2 by the magnetic attraction between the first magnet 30 and the second magnet 40.

As shown in FIG. 3, the present invention finally performs step S5. According to the magnetic attraction between the first magnet 30 and the second magnet 40, the printed circuit board 1 is tightly fixed to the supporting jig 2 to facilitate the SMT procedure.

Please note that the steps of the positioning method of the present invention are not limited to the abovementioned order. The step order can be adjusted as long as the object of the present invention can be achieved.

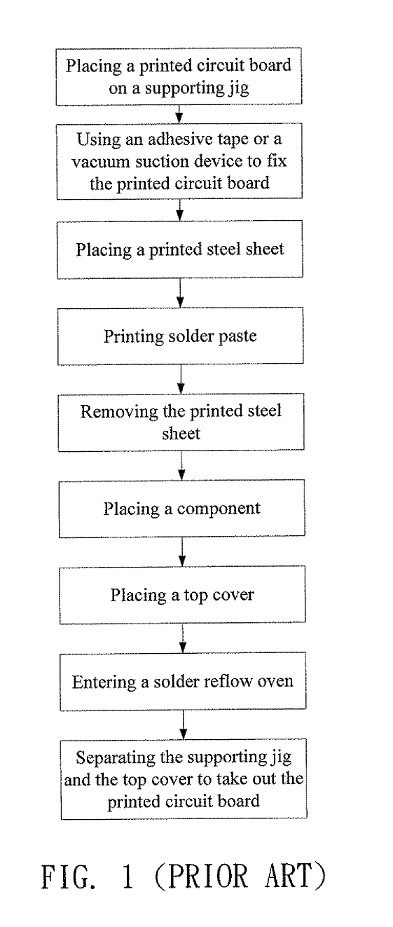

According to the above description, the magnetic attraction between the first magnet 30 and the second magnet 40 is sufficient enough to replace the fixing force required by the printed circuit board during the solder paste printing process and in the solder reflow oven in the known prior art as shown in FIG. 1. Therefore, by means of utilizing the printed circuit board 1 and the supporting jig 2 of the present invention, the expense of purchasing the vacuum suction device, the step of using the adhesive tape, or the labor power of covering the top cover can be saved, such that the entire SMT procedure is completely automated without the need of labor power or additional steps or devices. Further, the positioning method of the present invention skips the step of covering the top cover, thereby solving the problem of poor soldering quality caused by component shifting due to the placement of the top cover.

Although the present invention has been explained in relation to its preferred embodiments, it is to be understood that many other possible modifications and variations can be made without departing from the spirit and scope of the invention as hereinafter claimed.

What is claimed is:

1. A supporting jig, used for positioning a printed circuit board to facilitate a surface mount technology (SMT) procedure toward the printed circuit board, the printed circuit board comprising a circuit board locating hole and a first magnet, wherein the first magnet is accommodated in the circuit board locating hole, the supporting jig comprising:
a jig locating hole, located beneath the circuit board locating hole; and
a second magnet, accommodated in the jig locating hole, such that the printed circuit board is fixed on the supporting jig by the magnetic attraction between the first magnet and the second magnet.

2. The supporting jig as claimed in claim 1, wherein the second magnet is mounted in the jig locating hole through adhesion.

3. The supporting jig as claimed in claim 1, wherein the geometric shape of the second magnet matches the geometric shape of the jig locating hole.

4. The supporting jig as claimed in claims 3, wherein the second magnet is mounted in the jig locating hole through adhesion.

5. The supporting jig as claimed in claim 3, wherein the jig locating hole is a through hole.

6. The supporting jig as claimed in claim 5, wherein the second magnet is mounted in the jig locating hole through adhesion.

7. A printed circuit board, fixed on a supporting jig, used for performing a surface mount technology (SMT) procedure toward the printed circuit board, the printed circuit board comprising:
a circuit board locating hole; and
a first magnet, accommodated in the circuit board locating hole.

8. The printed circuit board as claimed in claim 7, wherein the geometric shape of the first magnet matches the geometric shape of the circuit board locating hole.

9. The printed circuit board as claimed in claim 8, wherein the thickness of the first magnet is substantially smaller than or equal to the depth of the circuit board locating hole.

10. The printed circuit board as claimed in claim 7, wherein a side cross-sectional shape of the circuit board locating hole is wide at the top and narrow at the bottom.

11. The printed circuit board as claimed in claim 10, wherein the geometric shape of the first magnet matches the geometric shape of the circuit board locating hole.

12. The printed circuit board as claimed in claim 11, wherein the thickness of the first magnet is substantially smaller than or equal to the depth of the circuit board locating hole.

13. The printed circuit board as claimed in claim 12, wherein the printed circuit board is a light emitting diode (LED) light bar.

14. The printed circuit board as claimed in claim 10, wherein the side cross-sectional shape of the circuit board locating hole is rectangular.

15. The printed circuit board as claimed in claim 14, wherein the geometric shape of the first magnet matches the geometric shape of the circuit board locating hole.

16. The printed circuit board as claimed in claim 15, wherein the thickness of the first magnet is substantially smaller than or equal to the depth of the circuit board locating hole.

17. The printed circuit board as claimed in claim 16, wherein the printed circuit board is a light emitting diode (LED) light bar.

18. The printed circuit board as claimed in claim 10, wherein the side cross-sectional shape of the circuit board locating hole is taper.

19. The printed circuit board as claimed in claim 18, wherein the geometric shape of the first magnet matches the geometric shape of the circuit board locating hole.

20. The printed circuit board as claimed in claim 19, wherein the thickness of the first magnet is substantially smaller than or equal to the depth of the circuit board locating hole.

21. The printed circuit board as claimed in claim 20, wherein the printed circuit board is a light emitting diode (LED) light bar.

22. A positioning method, used for fixing a printed circuit board on a supporting jig to facilitate a surface mount technology (SMT) procedure toward the printed circuit board, the positioning method comprising the following steps:
providing a circuit board locating hole on the printed circuit board;
providing a jig locating hole on the supporting jig;
accommodating a first magnet in the circuit board locating hole;
accommodating a second magnet in the jig locating hole; and
fixing the printed circuit board on the supporting jig by the magnetic attraction between the first magnet and the second magnet.
